(19) United States
(12) Patent Application Publication
(10) Pub. No.: US 2009/0196569 A1
(43) Pub. Date: Aug. 6, 2009

(54) VIDEO TRAILER

(75) Inventors: Lalitha Agnihotri, Tarrytown, NY (US); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/598,067

(22) PCT Filed: Feb. 18, 2005
(86) PCT No.: PCT/IB05/50611

§ 371 Date: Aug. 17, 2006

(30) Foreign Application Priority Data
Feb. 24, 2004 (EP) 04100713.9

(51) Int. Cl. H04N 5/93; H04N 7/173

(52) U.S. Cl. 386/52; 725/134

(57) ABSTRACT

A method of creating a collection (300) of relevant video segments (302-314) by selecting respective portions (202-214) from a video stream (200) which corresponds to a video program is disclosed. The collection (300) of relevant video segments (302-314) can be applied as video trailer or as video abstract. Hence the duration of the collection of relevant video segments is relatively short compared with the duration of the video program. The method comprises retrieving a further collection (201) of relevant images (222-234) corresponding to the video program; selecting a first video image from the video stream on basis of a comparison which is based on a first one of the relevant images (222) of the further collection (201) and the first video image; and creating a first one (302) of the relevant video segments (302-314) on basis of the selected first video image.

The invention relates to a method of creating a collection of relevant video segments by selecting respective portions from a video stream which corresponds to a video program, a first duration of the collection of relevant video segments being relatively short compared with a second duration of the video program.

The invention further relates to a video segment compilation unit for creating a collection of relevant video segments by selecting respective portions from a video stream which corresponds to a video program, a first duration of the collection of relevant video segments being relatively short compared with a second duration of the video program.

The invention further relates to a video storage system comprising:

a receiving unit for receiving a video stream;

storage means for storage of the video stream and for storage of a collection of relevant video segments being selected from the video stream; and

a video segment compilation unit for creating the collection of relevant video segments, as described above.

The invention further relates to a computer program product to be loaded by a computer arrangement, comprising instructions to create a collection of relevant video segments by selecting respective portions from a video stream which corresponds to a video program, a first duration of the collection of relevant video segments being relatively short compared with a second duration of the video program, the computer arrangement comprising processing means and a memory.

The amount of audio-video information that can be accessed and consumed in people's living rooms has been ever increasing. This trend may be further accelerated due to the convergence of both technology and functionality provided by future television receivers and personal computers. To select the audio-video information that is of interest, tools are needed to help users extract relevant audio-video information and to effectively navigate through the large amount of available audio-video information. To allow users to get a quick overview of the recorded audio-video information, and to decide whether to view an entire recorded video program, an interesting feature is the automatic generation of video trailers. When a video program has been or is recorded, the recorded video program is analyzed in order to select relevant video segments from the video stream. By afterwards displaying the relevant video segments the user is provided with a nice overview of the recorded video program.

An embodiment of the method of the kind described in the opening paragraph is known from the article “Video Abstracting”, by R. Lienhart, et al., in Communications of the ACM, 40(12), pages 55-62, 1997. This article discloses that video data may be modeled in four layers. At the lowest level, it consists of a set of frames; at the next higher level, frames are grouped into shots or continuous camera recordings, and consecutive shots are aggregated into scenes based on story-telling coherence. All scenes together make the video. The concept of a clip is described as a frame sequence being selected to be an element of the abstract; a video abstract thus consists of a collection of clips. The known method comprises three steps: segmentation and analysis of the video content; clip selection and clip assembly. The goal of the analysis step is to detect special events such as close-ups of the main actors, gunfire, explosions and text. A disadvantage of the known method is that it is relatively complex and not robust.

It is an object of the invention to provide method of the kind described in the opening paragraph which is relatively easy and results in a collection of relevant video segments of relatively high quality.

This object of the invention is achieved in that the method comprises:

retrieving a further collection of relevant images corresponding to the video program;

selecting a first video image from the video stream on basis of a comparison which is based on a first one of the relevant images of the further collection and the first video image; and

creating a first one of the relevant video segments on basis of the selected first video image.

In other words, the creation of the collection of relevant video segments is based on another, i.e. further collection of relevant images corresponding to the same video program. A common marketing technique to attract viewers to watch, buy or download a certain video program is the trailer, i.e. the further collection of relevant images. Trailers are short appetizers of a certain video program designed to tease consumers and raise their interest for specific content. They serve as advertisements for produced movies, TV programmes and all kind of footage. They are usually broadcast in clear and their download is free and encouraged. Users are accustomed to seeing trailers before buying or watching a certain video program. In fact, electronic program guides (EPG) use trailers when available to list the available video programs.

With images is meant visual information only but alternatively the combination of visual and audio information, i.e. pixel matrices only or pixel matrices combined with their audio track. The matching, i.e. the comparison can be based on visual information only, audio information only or on both audio and visual information.

The importance of video trailers has been recognized even by the international industrial forum for standardization of metadata, and EPG known as TV Anytime. The TV Anytime standard standardizes a mechanism to allow broadcaster to associate a trailer of a video program with the actual broadcast of the full-length video program. In this way consumer systems can recorded without any effort trailers and associated video programs. Alternatively, trailers are downloaded from Internet.

Trailers downloaded from Internet or embedded in an EPG service usually have a poor resolution and substantially worse quality than the full-length video stream corresponding to the video program. Furthermore these trailers are often very short. With the method according to the invention it is possible to create a collection of relevant video segments, i.e. an enhanced trailer or enhanced video abstract of a video program on basis of a retrieved trailer of lower quality and/or length and on basis of the video stream. Eventually, the newly created collection of relevant video segments can e.g. be used for browsing the collection of available recorded video programs.

In an embodiment of the method according to the invention the comparison comprises determining a first identification of the first one of the images on basis of fingerprinting and determining a second identification of the first video image and establishing a correspondence between the first identification and the second identification. A fingerprint, often also referred to as signature or hash, is a concise digest of the most relevant perceptual features of a signal. Unlike cryptographic hashes that are extremely fragile (flipping a single bit of the source data will in general result in a completely different hash), fingerprints are herein understood to be robust. That is, if source signals are perceptually similar, then the corresponding fingerprints are also very similar. Fingerprints are therefore used to identify audiovisual contents. An example of a method of generating a fingerprint for a multimedia object is described in European patent application number 01200505.4 (attorney docket PHNL010110), as well as in “Robust Audio Hashing For Content Identification”, by Jaap Haitsma, Ton Kalker and Job Oostveen, in International Workshop on Content-Based Multimedia Indexing, Brescia, September 2001. The following articles also describe similar techniques. “Visual Associations in DejaVideo”, by N. Dimitrova, Y. Chen, L. Nikolovska, at the Asian Conference on Computer Vision, Taipei, January 2000. “Feature extraction and a database strategy for video fingerprinting”, by Oostveen J. C., Kalker A. A. C., Haitsma J. A. at VISUAL 2002, 5^{th} international conference on recent advances in visual information systems, Hsin Chu, 2002.

The fingerprints might be related to the number and size of objects in the image. Optionally, the fingerprint is related to the presence of the faces.

In another embodiment of the method according to the invention the comparison is based on visual features. Options are e.g. color histograms, texture histograms, shaped descriptors. Alternatively, other types of comparison are used, is e.g. based on computing differences between images. Typically the spatial resolution of images of the further collection of relevant images is lower than the resolution of the images of the video stream. In order to compare respective images from the collection and the video stream, intermediate images are computed by downscaling the images of the video stream into the spatial resolution of the relevant images. Subsequently, these intermediate images are used for comparison. Preferably, the comparison based on pixel differences is performed by means of computing absolute pixel value differences. With pixel values is meant luminance and/or color.

Alternatively the matching is based on text from closed captions or speech to text transcripts.

In an embodiment of the method according to the invention a first one of the relevant video segments is created by selecting a sequence of video images which are temporally located around the selected first video image. In order to create a collection of relevant video segments with a first duration which is longer than the duration of the further collection of relevant images and still maintain the original order and structure, the number of selected video images is higher than the number of images of the first collection of relevant images. In order not to introduce unwanted jumps in the segments of the collection of relevant video segments, visual continuity must be checked when creating the segments. That means that each segment can be expanded only until the adjacent shot boundaries.

Other very similar segments could be inserted to expand the collection of relevant video segments to even longer duration. For this purpose, video segment similarity can be measured using any known video retrieval technique such as colour histogram matching, etc.

The length, i.e. duration, of the selected video segments might be equal to a predetermined value. But preferably the duration is controllable by a user. Optionally the duration of the video segments is related to the duration of the video program or to the number of selected video segments.

It is another object of the invention to provide a video segment compilation unit of the kind described in the opening paragraph which is arranged to create a collection of relevant video segments in a relatively easy way and resulting in a collection of relevant video segments of relatively high quality.

This object of the invention is achieved in that video segment compilation unit comprises:

retrieving means for retrieving a further collection of relevant images corresponding to the video program;

selecting means for selecting a first video image from the video stream on basis of a comparison which is based on a first one of the relevant images of the further collection and the first video image; and

creating means for creating a first one of the relevant video segments on basis of the selected first video image.

It is another object of the invention to provide a video storage system of the kind described in the opening paragraph which is arranged to create a collection of relevant video segments in a relatively easy way and resulting in a collection of relevant video segments of relatively high quality.

This object of the invention is achieved in that the video segment compilation unit of the video storage system, comprises:

retrieving means for retrieving a further collection of relevant images corresponding to the video program;

selecting means for selecting a first video image from the video stream on basis of a comparison which is based on a first one of the relevant images of the further collection and the first video image; and

creating means for creating a first one of the relevant video segments on basis of the selected first video image.

In an embodiment of the video storage system according to the invention the storage means comprises a hard-disk. In another embodiment of the video storage system according to the invention the storage means is arranged to store the video stream on a removable memory device, i.e. removable storage medium, like an optical-disk. A video segment compilation unit in accordance with the invention could be included, for example, in a television set, a computer, a video recorder (VCR), a DVD recorder, a set-top box, satellite-tuner or other apparatus in the field of consumer electronics. The invention can be applied in stationary or portable devices with video recording capabilities such as personal infotainment companions, media servers.

It is another object of the invention to provide a computer program product of the kind described in the opening paragraph which is arranged to create a collection of relevant video segments in a relatively easy way and resulting in a collection of relevant video segments of relatively high quality.

This object of the invention is achieved in that the computer program product, after being loaded, providing said processing means with the capability to carry out:

retrieving a further collection of relevant images corresponding to the video program;

selecting a first video image from the video stream on basis of a comparison which is based on a first one of the relevant images of the further collection and the first video image; and

creating a first one of the relevant video segments on basis of the selected first video image.

Modifications of the video segment compilation unit and variations thereof may correspond to modifications and variations thereof of the video storage system, the method and the computer program product described.

These and other aspects of the method, of the video segment compilation unit and of the video storage system according to the invention will become apparent from and will be elucidated with respect to the implementations and embodiments described hereinafter and with reference to the accompanying drawings, wherein:

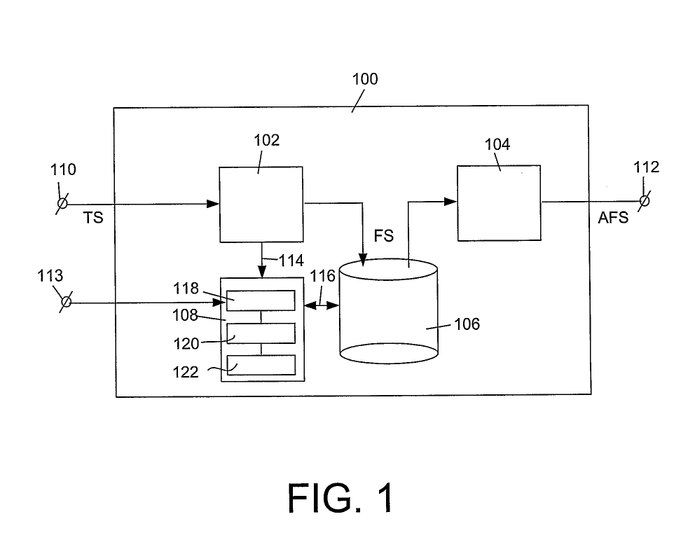

FIG. 1 schematically shows an embodiment of a recording and reproducing apparatus according to the invention; and

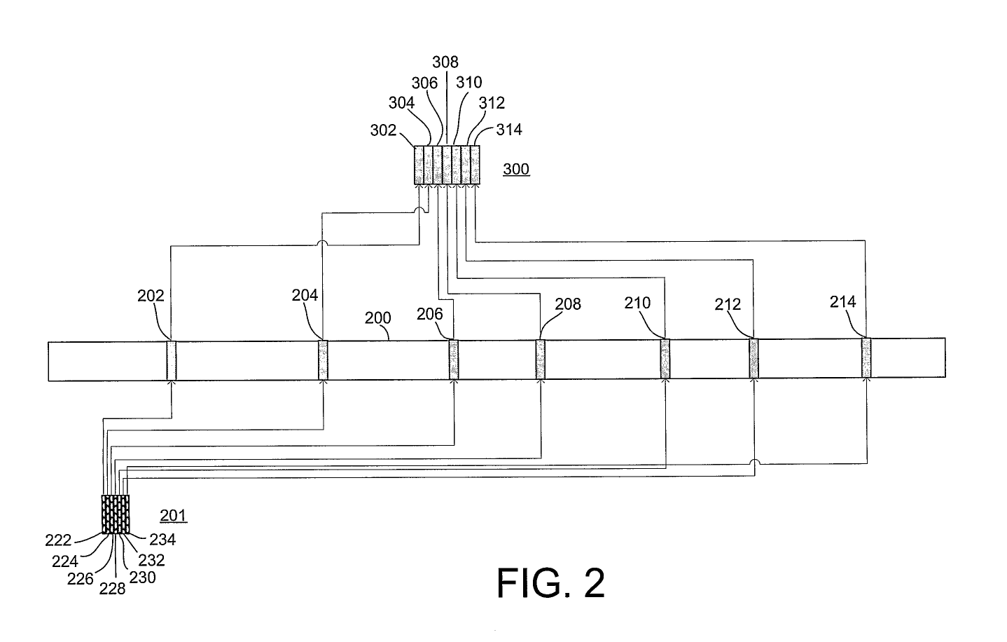

FIG. 2 schematically shows the creation of an enhanced video trailer on basis of a video stream, according to the invention.

Same reference numerals are used to denote similar parts throughout the figures.

A video program might be a television program as broadcast by a television station, i.e. television broadcaster. Typically the television program will be watched by means of television sets. However a video program might also be provided by another type of content provider, e.g. by means of the Internet. In that case the video program might be watched by other types of equipment than television sets. Alternatively the video program is not broadcast but exchanged by means of removable media, like optical-disks, solid-state memory devices or cassette tapes. In this disclosure examples are described in which the video program is a television program. It will be clear that the invention has a broader scope.

A television signal comprises picture information, sound information and additional information, such as for example teletext information. The television signal transmits a television program. The television program can comprise a movie or film, an episode of a series, a captured reproduction of a theater performance, a documentary or a sports program. These types of information of the television program may be interrupted by a plurality of units of commercial-break information and announcement information.

FIG. 1 schematically shows an embodiment of a recording and reproducing apparatus 100 according to the invention. This recording and reproducing apparatus 100 is a hard-disk based video storage system. The recording and reproducing apparatus 100 is adapted to record a television signal FS contained in the received signal TS and to reproduce a recorded television signal AFS. The received signal TS may be a broadcast signal received via an antenna, cable or satellite, but may also be a signal from a storage device like a VCR (Video Cassette Recorder) or Digital Versatile Disk (DVD). The received signal TS is provided by means of the input connector 110. The reproduced television signal AFS is provided at the output connector 112 and can be displayed by means of a display device, e.g. comprised by a television set.

The recording and reproducing apparatus 100 includes:

a receiving unit 102 for receiving the signal TS. This receiving unit 102, e.g. tuner, is arranged to select the television signal FS of a television station. This television signal FS represents a video stream which corresponds to a television program 200;

a recording and reproducing means 106 for storage of the video stream as provided by the receiving unit 102. The recording and reproducing means 106 include a signal processing stage for processing the television signal FS to be recorded and for processing the reproduced television signal AFS, as is commonly known. This processing stage might include data compression. The recording and reproducing means 106 include a hard-disk as recording medium for the recording of the processed television signal FS.

an exchange unit 104 for adaptation of stored information to a reproduced television signal AFS and for transmission of this a reproduced television signal AFS via the output connector 112, e.g. to a television set. The adaptation might include modulation on a carrier of the television signal FS representing the video stream. The stored information comprises the video stream as provided by the receiving unit 102 and a collection 300 of relevant video segments 302-314; and

a video segment compilation unit 108 for creating such a collection 300 of relevant video segments 302-314 by selecting respective portions 202-214 from the video stream which corresponds to the television program 200. The purpose of this video segment compilation unit 108 is to create a video trailer or alternatively a video abstract of the video stream. Hence the duration of the collection 300 of relevant video segments 302-314 is relatively short compared with the duration of the television program 200. E.g. a television program takes about 1 or 2 hours and the duration of the collection 300 of relevant video segments 302-314 is in the range of seconds to minutes. That means e.g. from 10 seconds to 2 minutes. As a consequence each of the relevant video segments 302-314 lasts only a few seconds. On user request the duration of the relevant video segments 302-314 to be selected might be shorter or longer. It is not required that all relevant video segments have the same length. It is also not required that the order of the relevant video segments is equal to the order in the video trailer. The creation of the collection of relevant video segments 302-314 can be performed during the recording of the video stream or after the recording has finished. In the former case the video stream 200 is provided by means of connection 114 and in the latter case the video stream is provided by means of connection 116.

The video segment compilation unit 108 comprises:

a second retrieving unit 118 for retrieving a further collection 201 of relevant images 222-234 corresponding to the video program 200. The second retrieving unit 108 is arranged to extract the further collection 201 of relevant images 222-234 via the second input connector 113 which is connected to the Internet. The second retrieving unit 108 is arranged to download a trailer from the Internet. Alternatively, the second retrieving unit 108 is arranged to extract the further collection of relevant images via the signal TS which is received by the receiving unit 102, e.g. the second retrieving unit 108 is arranged to retrieve the trailer from the EPG;

a selection unit 120 for selecting video images from the video stream on basis of comparison. The comparison is based the relevant images of the further collection with respective video images of the video stream; and

a segment creation unit 122 for creating the relevant video segments on basis of the selected video images. That means that a number of images preceding and/or succeeding the selected video images are used to form the various relevant video segments 302-314.

The collection 300 of relevant video segments 302-314 can be stored as a number of copies of the respective portions of the original video stream. But preferably only a set of pointers is stored. The pointers indicate start or stop locations within the video stream corresponding to begin or end, respectively of the selected portions of the video stream. The collection of relevant video segments, as video data or as pointers, can be stored in the same memory device as applied for the storage of the original video stream or in a separate memory device. It will be clear that in the case of a recording and reproducing apparatus which is based on a removable storage medium it is preferred that both video stream and collection of relevant video segments are stored on the same storage medium.

The second retrieving unit 118, the selection unit 120 and the segment creation unit 122 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

While the video segments of the trailer can be completely replaced with the corresponding ones from the recorded video program, i.e. the video stream, the associated audio track can be left untouched because professionally produced trailers usually have a different audio track and use the voice of a narrator to convey additional information about the video program. Alternatively, the higher quality audio track of the recorded video program can be used or mixed with the one of the trailer. Alternatively the narrator's voice of the trailer sound track can be extracted using voice filtering (the same technique used to remove the voice in karaoke systems) and added to the high quality sound track of the recorded video program.

FIG. 2 schematically shows the creation of an enhanced video trailer 300 on basis of a video stream 200, according to the invention. To create the enhanced video trailer 300 a pre-created video trailer 201 is used. Typically, such a pre-created video trailer 201 is shorter in time than the enhanced video trailer 300 and the images of the pre-created video trailer 201 have a lower spatial resolution than the images of the enhanced video trailer 300. The pre-created video trailer 201 comprises a number of short sequences of images. For each of the sequences a characteristic is determined. Preferably multiple images of such a sequence are used to create one characteristic, i.e. a fingerprint. Alternatively, only a single image out of each sequence is selected to create such a characteristic. For the images of the video stream 200 similar characteristics are determined. Alternatively, only for a subset of the images, e.g. one out of ten images, these characteristics are determined. On basis of the characteristics of the two data sets, i.e. the video stream and the pre-created video trailer, a matching procedure is started. If a match between data derived from the pre-created video trailer 201 and data derived from the video stream 200 is established, then a number of images of the video stream are selected to be used for the enhanced video trailer 300.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. A method of creating a collection (300) of relevant video segments (302-314) by selecting respective portions (202-214) from a video stream (200) which corresponds to a video program, a first duration of the collection (300) of relevant video segments (302-314) being relatively short compared with a second duration of the video program, the method comprising:
retrieving a further collection (201) of relevant images (222-234) corresponding to the video program;
selecting a first video image from the video stream on basis of a comparison which is based on a first one of the relevant images (222) of the further collection (201) and the first video image; and
creating a first one (302) of the relevant video segments (302-314) on basis of the selected first video image.

2. A method of creating a collection (300) of relevant video segments (302-314) as claimed in claim 1, whereby the comparison comprises determining a first identification of the first one of the images on basis of fingerprinting and determining a second identification of the first video image and establishing a correspondence between the first identification and the second identification.

3. A method of creating a collection (300) of relevant video segments (302-314) as claimed in claim 1, whereby the comparison is based on visual features.

4. A method of creating a collection (300) of relevant video segments (302-314) as claimed in claim 1, whereby the further collection (201) of relevant images is retrieved from the Internet.

5. A method of creating a collection (300) of relevant video segments (302-314) as claimed in claim 1, whereby the further collection (201) of relevant images is retrieved from a broadcast channel via which the video stream is broadcast.

6. A method of creating a collection (300) of relevant video segments (302-314) as claimed in claim 1, whereby the further collection (201) of relevant images is retrieved from an EPG.

7. A method of creating a collection (300) of relevant video segments (302-314) as claimed in claim 1, whereby the first one (302) of the relevant video segments (302-314) is created by selecting a sequence of video images (202) which are temporally located around the selected first video image.

8. A video segment compilation unit for creating a collection (300) of relevant video segments (302-314) by selecting respective portions (202-214) from a video stream (200) which corresponds to a video program, a first duration of the collection (300) of relevant video segments (302-314) being relatively short compared with a second duration of the video program, the video segment compilation unit comprising:
retrieving means (118) for retrieving a further collection (201) of relevant images corresponding to the video program;
selecting means (120) for selecting a first video image from the video stream on basis of a comparison which is based on a first one of the relevant images of the further collection (201) and the first video image; and
creating means (122) for creating a first one of the relevant video segments on basis of the selected first video image.

9. A video storage system (100) comprising:
a receiving unit (102) for receiving a video stream (200);
storage means (106) for storage of the video stream (200) and for storage of a collection (300) of relevant video segments (302-314) being selected from the video stream (200); and
a video segment compilation unit (108) for creating the collection (300) of relevant video segments (302-314), as claimed in claim 8.

10. A computer program product to be loaded by a computer arrangement, comprising instructions to create a collection (300) of relevant video segments (302-314) by selecting respective portions (202-214) from a video stream (200) which corresponds to a video program, a first duration of the collection (300) of relevant video segments (302-314), the computer arrangement comprising processing means and a memory, the computer program product, after being loaded, providing said processing means with the capability to carry out:
retrieving a further collection (201) of relevant images (222-234) corresponding to the video program;
selecting a first video image from the video stream on basis of a comparison which is based on a first one of the relevant images (222) of the further collection (201) and the first video image; and
creating a first one (302) of the relevant video segments (302-314) on basis of the selected first video image.
